(19) United States
(12) Patent Application Publication
(10) Pub. No.: US 2005/0051959 A1
(43) Pub. Date: Mar. 10, 2005

(54) Apparatus and method for carrying out and monitoring currency--chip transactions in casino

(76) Inventors: William C. Farley, Turnersville, NJ (US); Sean McManimon, Egg Harbor Township, NJ (US)

Correspondence Address: TOD R. NISSLE, P.C., P.O. Box 55630, Phoenix, AZ, 85078, US

(21) Appl. No.: 10/660,039

(22) Filed: Sep. 9, 2003

(51) Int. Cl. A63F 13/00

(52) U.S. Cl. 273/274

(57) ABSTRACT

An apparatus and method for exchanging gambling chips for currency and vice-versa. The apparatus monitors the quantity of chips received and dispensed by reading unique identification data encoded on the chips.

This invention relates to the issuance and/or exchange of currency and casino chips.

More particularly, the invention relates to a method and apparatus for monitoring the exchange of chips and currency in a casino.

Gambling chips are presently dispensed in a casino by a casino employee who accepts currency from a patron and, in exchange, gives chips to the patron. Similarly, when the patron turns in his chips, he gives the chips to a casino employee who, in exchange, dispenses an equivalent amount of currency to the patron. While this time-honored process has long existed in casinos, it requires that the casino hire and train employees, as well as, in many cases, carry out a background check on the employee. In addition, it is difficult to monitor in real time whether an employee is making errors when he exchanges chips and currency. Audits can always be carried out, but these are usually some time after the fact.

Accordingly, it would be highly desirable to provide an improved method and apparatus for exchanging currency and chips at a casino so that the employee overhead costs could be minimized and so that the accuracy of chip-currency transfer transactions could be monitored and confirned as soon as the transaction was completed.

Therefore, it is a principal object of the invention to provide an improved method and apparatus for exchanging currency and gambling chips in a casmo.

Another object of the invention is to provide an improved method for issuing concurrently chips and currency in a casino.

A further object of the invention is to provide an improved method and apparatus for monitoring each currency-chip exchange at a gambling table in a casino.

These and other, further and more specific objects and advantages of the invention will be apparent to those skilled in the art from the following detailed description thereof, take in conjunction with the drawings, in which:

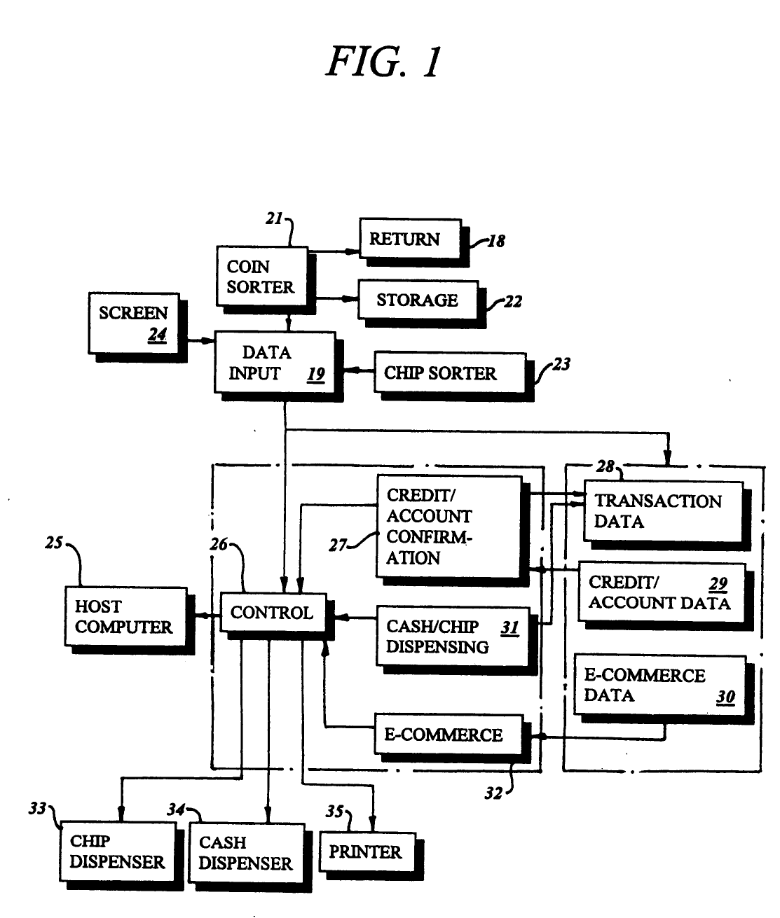

FIG. 1 is a block diagram illustrating currency-chip exchange apparatus constructed in accordance with the principles of the invention;

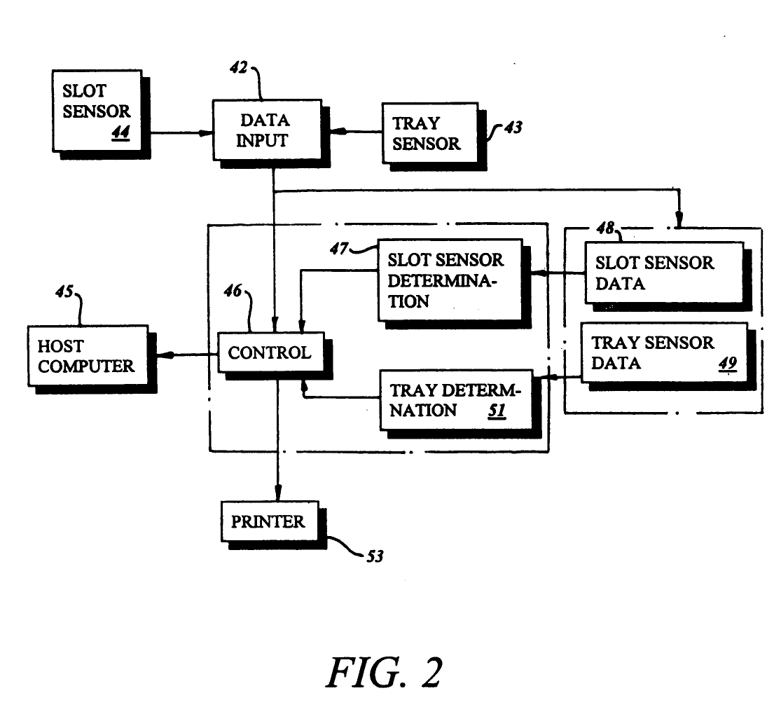

FIG. 2 is a block diagram illustrating a system for monitoring a currency-gambling chip exchange at a gambling table in a casino to determining whether equivalent amount of currency and chips have been exchanged at the table; and,

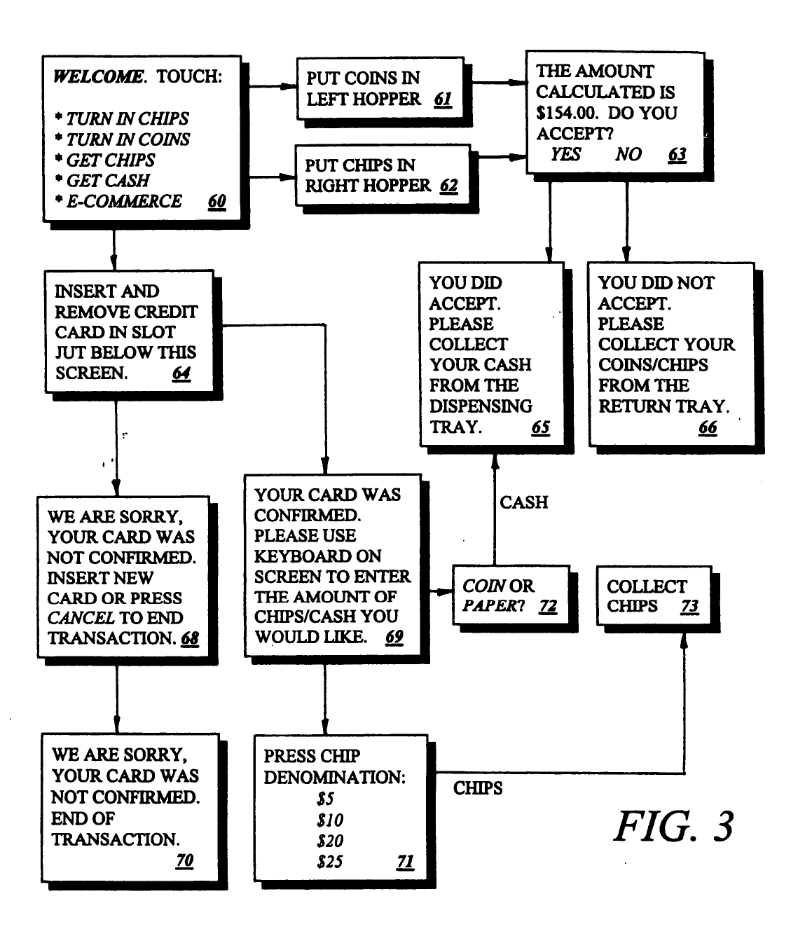

FIG. 3 is a block diagram illustrating a series of interactive informational commands which can appear on the television screen of apparatus which accepts casino chips and currency in accordance with the invention.

Briefly, in accordance with our invention, we provide an improved machine for exchanging gambling chips for currency. The machine includes apparatus for receiving a plurality of gambling chips, determining the denomination of each chip, and determining the total value of each chip; and, apparatus for dispensing an amount of currency equivalent to the total value of the plurality of chips.

In another embodiment of the invention, we provide a method for monitoring a currency-chip transaction at a gambling table in a casino. The method includes the steps of determining with at least one sensor the value of chips dispensed to a casino patron; determining with at least one sensor the value of currency presented by the casino patron in payment of the chips; and, comparing the value of the chips dispensed with the value of the currency presented to the casino patron.

In a further embodiment of the invention, we provide a machine for issuing gambling chips. The machine includes apparatus for charging a selected currency amount to a credit card; and, apparatus for issuing a quantity of chips with a value equivalent to the selected currency amount.

Turning now to the drawings, which depict the presently preferred embodiments of the invention for the purpose of illustrating the invention and not by way of limitation of the scope of the invention, and in which like reference characters refer to corresponding elements throughout the several views, FIG. 1 illustrates apparatus for issuing currency and for exchanging currency and gambling chips in accordance with the invention. The apparatus includes a coin sorter 21, chip sorter 23, and screen 24 each of which provide data to data input 19. Data input 19 directs data to a controller and memory. The coin sorter 21 and chip sorter 23 each include a return 18 and storage 22, although in FIG. 1 only the return and storage for coin sorter 21 are illustrated.

The controller includes control 26, credit/account confirmation sub-routine 27, cash/chip dispensing sub-routine 31, and e-commerce sub-routine 32. The controller communicates with a host computer 25 and with chip dispenser 33, cash dispenser 34, and printer 35.

The memory includes transaction data 28, credit-account data 29, and e-commerce data 30.

A sample series of informational instructions which appear on screen 24 are illustrated in FIG. 3 and are utilized in describing how the apparatus of FIG. 1 works in the following examples.

### EXAMPLE I

A user views screen 24 and sees display 60:
WELCOME. TOUCH:
   TURN IN CHIPS
   TURN IN COINS
   GET CHIPS
   GET CASH
      If the user wishes to TURN IN CHIPS or TURN IN COINS, he touches either of these on screen 24. If the user touches or presses the screen immediately over TURN IN CHIPS, the display 62 appears:
PUT CHIPS IN
RIGHT HOPPER
   If the user touches TURN IN COINS, the display 61 appears:
PUT COINS IN
LEFT HOPPER
   As used herein, “pressing” or “touching” a word or phrase in a display which appears on screen 24 means that a user places the tip of one of his fingers on (i.e., contacts) the screen 24 over the word or phrase appearing on the screen.

After the user places coins or gambling chips, as the case may be, in the appropriate hopper, the apparatus processes the coins or chips through separating and scanning apparatus and determines to total amount of currency represented by the coins or chips. The separating apparatus separates out coin-shaped objects (like metal blanks) which are not coins or chips, as the case may be. The scanning apparatus comprises radio frequency sensors, infrared sensors, bar code scanners, ink sensors, or any other prior art equipment for reading symbols or markings on a chip or coin or for sending and/or receiving signals from a microprocessor, transmitter, etc. on a coin or chip. The signals can include data defining the unique identification number, denomination (value), name of casino, and/or other information used to identify the chip or coin and to assign a denomination (value) to the chip or coin.

After the chips or coins are processed by separating and scanning apparatus, they are deposited in an intermediate holding bin in the apparatus.

Equipment for processing gambling chips or coins is well known in the art. Such apparatus can separate out tokens which do not comprise coins or do not comprise a desired type of poker chip, can determine the value of each coin or chip, and can determine the total value represented by the chips or coins.

The coin sorter 21 or chip sorter 23, as the case may be, transmits data to data input 19. This data can comprises any desired information, but typically can, by way of example, include the denomination of each chip or coin (or the cumulative value of all of the chips), the unique serial number of each chip, or the name of the casino in which the chips are used.

Data input 19 transmits to the controller and to memory the data provided by the coin sorter and chip sorter. The cash/chip dispensing sub-routine 31 calculates the total value of all the coins (or gambling chips) placed in the apparatus. In the example represented by FIG. 3, the total value of all the coins (or gambling chips) placed in the apparatus is $154.00. The following display 63 appears on the screen 24:
THE AMOUNT
CALCULATED IS
$154.00. DO YOU
ACCEPT?
YES NO
   If the user accepts the $154.00 total value of the coins or chips determined by the apparatus, he presses the YES on the screen. If the user does not accept the $154.00 total, he presses the NO on the screen.

When the user presses the NO, the sub-routine 31, via control 26, issues a command to the intermediate holding bin to dispense to the return 18 tray the coins or chips which the patron originally put in the apparatus to be exchanged, and the following display 65 appears on the screen 24:
YOU DID NOT
ACCEPT.
PLEASE
COLLECT YOUR
COINS/CHIPS
FROM THE
RETURN TRAY.

When the user presses screen 24 above YES, the sub-routine 31, via control 26, commands the intermediate holding bin to dispense to the storage 22 bin in the apparatus the coins or chips which the patron originally put in the apparatus. The sub-routine 31 then, via control 26, commands apparatus to cause cash dispenser 34 to dispense to the patron $154.00 cash in the form of three $50.00 dollar bills and four $1.00 bills.

### EXAMPLE II

A user views screen 24 and sees display 60:
WELCOME. TOUCH:
   TURN IN CHIPS
   TURN IN COINS
   GET CHIPS
   GET CASH
      If the user wishes to GET CHIPS or GET CASH, he touches either of these on screen 24. The sub-routine 27 causes display 64 to appear on screen 24:
INSERT AND
REMOVE CREDIT
CARD IN SLOT
JUST BELOW
THIS SCREEN.
   The user pulls his credit card (or bank card or other acceptable designated credit confirmation card or device) and the magnetic strip on the credit card through the slot in a credit card reader mounted in the apparatus just below screen 24 or at some other desired location in the apparatus. Any desired apparatus other than a magnetic strip reader can be utilized to read a credit device. The credit device might be the user's fingerprint, DNA, etc.

If the credit card is not confirmed or is denied, credit/account confirmation sub-routine 27 commands, via control 26, that the following display 68 appear on screen 24:
WE ARE SORRY
YOUR CARD WAS
NOT CONFIRMED.
INSERT NEW
CARD OR PRESS
CANCEL TO END
TRANSACTION.

If the user again runs the credit card through the credit card reader and the card is denied, credit/account confirmation sub-routine 27 commands that the following display 70 appear on screen 24:
WE ARE SORRY,
YOUR CARD WAS
NOT CONFIRMED.
END OF
TRANSACTION.

If, after a user runs the credit card through the credit card reader and the card is confirmed and accepted, sub-routine 27 commands that the following display 69 appear on screen 24:
YOUR CARD WAS
CONFIRMED.
PLEASE USE
KEYBOARD ON
SCREEN TO ENTER
THE AMOUNT OF
CHIPS/CASH YOU
WOULD LIKE.
   The user then touches the screen 24 over selected ones of ten buttons numbered 1, 2, 3, 4, 5, 6, 7, 8, 9, 0 to enter a desired number. The ten buttons appears on screen 24. For sake of this example, it is assumed that the user touches buttons 2, 5 and 0 in sequence to enter $250.00 as the quantity of chips or coins desired.

If the user had originally touched GET CASH, the cash/chip dispensing sub-routine 31 commands that the following display 72 appear on screen 24:
COIN OR
PAPER
   After the user touches the screen 24 above COIN then sub-routine 31 causes display 65 to appear on screen 24 and causes coins in the amount of $250.00 to be issued into the dispensing tray.

If, instead of touching GET CASH, the user had originally touched GET CHIPS, cash/chip dispensing sub-routine 31 commands that the following display 71 appear on screen 24:
PRESS CHIP
DENOMINATION:
   $5
   $10
   $20
   $25
      The user presses screen 24 immediately above $25. Sub-routine 31 causes display 73 to appear on screen 24 and causes chip dispenser 33 to dispense ten $25.00 chips. Sub-routine 31 also causes printer 35 to print a receipt for the user noting that the user charged $250.00 on his credit card.

### EXAMPLE III

A user views screen 24 and sees display 60:
WELCOME. TOUCH:
   TURN IN CHIPS
   TURN IN COINS
   GET CHIPS
   GET CASH
   E-COMMERCE
      If the user touches E-COMMERCE on screen 24, a menu appears which lists TRAVEL, ENTERTAINMENT, SPORTING GOODS, VEHICLES, or any other desired kind of goods and services. By touching the screen 24 over a particular item in the menu, the user is taken to another screen or web site offering the particular goods or services for sale so that the user can purchase such goods and services, make reservations, etc. and, if the user wishes, conduct e-commerce in conventional fashion by selecting on the Internet goods and/or services, and by then paying over the Internet for goods and services with a credit card or other financial card or account.

FIG. 2 illustrates a system for monitoring coin-currency transactions at a blackjack table, craps table, or other gaming table. The system include a slot sensor 44 for determining the denomination of each paper currency or coin currency inserted through a slot in the gaming table into a locked storage chamber in, adjacent, or connected to the gaming table. A tray sensor 43 determines the number of gambling chips in a tray or trays at the gaming table and identifies the denomination of each chip. Sensors for monitoring the number of chips in a tray and the denomination of each chip are known in the art and will not be detailed herein, as are systems for counting and identifying the denomination of each coin or piece of paper currency inserted through a slot. Both slot sensor 44 and tray sensor 43 provide data to data input 42. Data from data input 42 is provided to the controller and to memory.

The controller in FIG. 2 includes control 46 and slot sensor determination sub-routine 47 and tray determination sub-routine 51. The memory in FIG. 2 includes slot sensor data 48 and tray sensor data 49. Control 46 communicates with a remote host computer 45 and a printer 53.

In operation, when a patron at a gaming table purchases chips, the casino employee operating the table removes the necessary number of chips, for example six $20.00 denomination chips, from a chip tray or from other chip dispenser. Tray sensor 43 reads the CI matrix or other identifing data or code on each chip as the chip is removed from a chip tray or other chip dispenser. The chips are presently typically “read” one at a time by sensor 43 as the chips are removed from the chip dispenser. If desired, a sensor 43 can be provided which reads multiple chips simultaneously or nearly simultaneously when they are dispensed from the chip dispenser. The tray sensor 43 sends data to data input 42 confirming that six $20.00 chips have been removed from the chip tray or dispenser. The data can, by way of example and not limitation, include the unique identification number on each chip, the denomination of each chip, and the casino name on each chip. Data input 42 generates signals to the tray determination sub-routine 51 in the controller and to tray sensor data 49 in memory confirming that the chips were removed from the tray. The patron then, for example, gives the casino employee one $50.00 bill, three $20.00 bills, and one $10.00 bill (totaling $120.00). When the casino employee pushes these bills one at a time through the slot into the locked storage chamber, the slot sensor 44 sends data to data input 42 and, subsequently, to slot sensor data 48 and slot sensor determination sub-routine 47 confirming that each of these bills passed through the slot and confirming the denomination of each bill. Sub-routines 47 and 51 compare the value of the chips dispensed by the casino employee with the value of the currency inserted through the slot into the storage chamber. Since these values are identical, the transaction appears proper. If the value of the chips dispensed is not equivalent to the value of the currency, then a warning system is activated so that another individual monitoring the gaming table can shut down the table, replace the casino employee operating the table, or take any other desired action.

Although the casino chips utilized in the practice of the invention can be fabricated in any desired manner, the presently preferred chips are laser marked, imprinted, or otherwise provided with a CI matrix code and a foil or film is burned into the CI matrix to provide an additional level of security. The CI matrix code-marked casino or gaming chips are utilized in conjunction with a digital-high resolution color and symbol recognition system.

The CI matrix consists of a matrix of dots and spaces which define parallel rows and parallel columns. Each dot or space is immediately adjacent and horizontally aligned with at least one other dot or space and is immediately adjacent and vertically aligned with at least one other dot or space. Consequently, a square of ten rows of dots and spaces also is read as ten rows of dots and columns. The combination of dots and spaces in each row can, for example, equal a letter or number. Each particular sequence of dots and spaces equal an alphanumeric character. For example, if each row and column has ten characters consisting of dots or spaces, a certain combination of dots and spaces can equal a specific letter or number. A space is an open area with no dot or other mark. If the ten characters in row one consist of “space-space-space-space-space-space-space-space-space-dot”, this indicates the numeral 1. If row two consists of the ten characters “space-space-space-space-space-space-space-space-dot-dot”, this indicates the numeral 2. If row three consists of the ten characters “space-space-space-space-space-space-space-space-dot-dot”, this indicates the numeral 3. If row four consists of the ten characters “space-space-space-space-space-space-space-space-space-dot”, this ten character sequence is identical to row one and indicates the numeral 1. An so on. Each row can be read from left-to-right or right-to-left. Each column can be read from top-to-bottom or bottom-to-top. The characters in a matrix can also be read along a diagonal line which is canted with respect to the rows and columns.

Each CI matrix presently also include a reference mark or marks adjacent the matrix to facilitate identifying where to begin reading the matrix. For example, a line along the right hand side and/or bottom of the matrix can be utilized.

One advantage of a CI matrix is that it often can be utilized in a relatively small space, possibly 0.1 inch by 0.1 inch or smaller.

Therefore, a CI matrix on a chip can define a serial or identification number unique to that chip, can define the value or denomination of the chip, can identify the casino in which the chip is used, and can provide any other desired information.

When a chip is deposited in or removed from a machine utilized in the practice of the invention, a CI matrix on the chip is read with a camera or other sensor 43.

1. A method for monitoring a currency-chip transaction at a gambling table in a casino, including the steps of
(a) determining with at least one sensor the value of chips dispensed to a casino patron;
(b) determining with at least one sensor the value of currency presented by the casino patron in payment of the chips; and,
(c) comparing the value of the chips dispensed with the value of the currency presented to the casino patron.
